(19) United States
(12) Patent Application Publication
(10) Pub. No.: US 2008/0104688 A1
(43) Pub. Date: May 1, 2008

(54) SYSTEM AND METHOD FOR BLOCKING ANONYMOUS PROXY TRAFFIC

(75) Inventors: Trevor J. Paskett, Layton, UT (US); James D. Hegge, Vancouver, WA (US); Brent E. Nixon, Park City, UT (US)

Correspondence Address: THORPE NORTH & WESTERN, LLP., P.O. Box 1219, SANDY, UT, 84091-1219, US

(73) Assignee: Cymphonix Corporation, Sandy, UT (US)

(21) Appl. No.: 11/553,787

(22) Filed: Oct. 27, 2006

(51) Int. Cl. G06F 15/16; G06F 17/00; G06F 9/00

(52) U.S. Cl. 726/12; 726/13; 726/14

(57) ABSTRACT

A system and method are provided for blocking anonymous proxy traffic. The method can include the operation of receiving a data stream from an electronic communication network. Another operation can be checking the data stream to determine whether the data stream is being sent over a defined port number. The data stream that is not being sent over the defined port number can be tested to determine whether the data stream is a connected data stream. A user can be blocked from receiving the connected data stream that is not being sent over the defined port number.

### FIELD OF THE INVENTION

The present invention relates generally to managing network communications.

### BACKGROUND

The Internet has become a valuable network communication system. It allows people to send communications around the world in a matter of minutes, access websites, and download information from a nearly unlimited number of remote locations. The Internet includes a collection of hosting servers and clients that are connected in a networked manner. In addition to the servers and client computers, there are other significant components that enable the Internet to function. Some of the components the Internet uses to transfer information include routers, gateways, switches, hubs and similar network devices.

One device of interest is a router. Routers can be considered specialized electronic devices that help send messages, information, and Internet packets to their destinations along thousands of pathways. Much of the work to get a message from one computer to another computer on a separate network is done by routers, because routers enable packets to flow between interconnected networks rather than just within localized networks. Routers receive packets from the one or more networks that they are connected to and then determine to which network the packets should be forwarded. For example, a router for a local network may receive a packet that should be kept within the network because it uses a local address. This same router will also receive packets that may need to be sent to the Internet because the packets have an Internet address.

Internet data for a message or file is broken up into packets about 1,500 bytes long. Each of these packets has a wrapper that includes information about the sender's address, the receiver's address, the packet's place in the entire message, and how the receiving computer can be sure that the packet arrived intact. Each data packet is sent to its destination via the best available route—a route that might be taken by all the other packets in the message or by none of the other packets in the message. The advantage of this scheme is that networks can balance the load across various pieces of equipment on a millisecond-by-millisecond basis. If there is a problem with one piece of equipment in the network while a message is being transferred, packets can be routed around the problem, ensuring the delivery of the entire message.

In addition to the addressing information, a packet includes a data portion that is the original information being transmitted. Data packets can be classified by the protocol used to send the information, the application being used to originate the information and the user or machine generating the network traffic, among many others. A data stream that is sent during a session is a plurality of data packets which convey the original message.

Every piece of equipment that connects to a network has a physical address, regardless of whether the equipment is located on an office network or the Internet. This is an address that is unique to the piece of equipment that is actually attached to the network cable. For example, if a desktop computer has a network interface card (NIC) in it, the NIC has a physical address permanently stored in a special memory location. This physical address, which is also called the MAC address (Media Access Control), has two parts that are each 3 bytes long. The first 3 bytes identify the company that made the NIC. The second 3 bytes are the serial number of the NIC itself.

A computer can have several logical addresses at the same time. This enables the use of several addressing schemes, or protocols, from several different types of networks simultaneously. For example, one address may be part of the TCP/IP network protocol or another networking protocol. The network software that helps a computer communicate with a network takes care of matching the MAC address to a logical address. The logical address is what the network uses to pass information along to a computer.

There are many different network transport protocols, each of which has various behaviors in a data network. One example is the HTTP (HyperText Transfer Protocol) which is used to send and receive data over the Internet and other networks. This protocol was originally designed to send and receive as much data as possible over any available network connection. This results in its ability to be used on slow “dial-up” connections as well as fast “broadband” network connections to the Internet. This ability also makes it a greedy protocol because it will take any available bandwidth, to the point of causing congestion or contention among other applications or protocols that may also be using the network. Many other network protocols are designed this way due to the historical time period during which they were designed or the desire to capture as much bandwidth as possible for any given communication session.

Due to the large variety and amount of traffic that can be transferred over a network connections from the Internet, there are many companies, government offices, schools, and other groups employ Internet filtering in order to block unwanted Internet content in specific subject categories. Generally businesses or organizations block topics or websites that they believe negatively impact their overall productivity and/or network bandwidth. For example, shopping, gaming, pornography, news, and other websites may be blocked by a content filter. When a user request is blocked by a content filter, the user typically receives a web page telling the user that the specific content has been blocked.

However, it is possible to defeat such content filters, even if the end user is not particularly technically savvy. Many users are able to use anonymous proxy servers to avoid detection by the content filters. A proxy server is a server that sits between a client application, (such as a web browser or a client device) and a target server that contains desired information. A proxy server can be configured to intercept all the network requests to the target server to see if the proxy server can fulfill the requests itself. In the case of an anonymous proxy server, the proxy server is employed to make requests to the target server and then to pass the data back to the client in an anonymous fashion which circumvents the client network's content filtering system.

### SUMMARY OF THE INVENTION

A system and method are provided for blocking anonymous proxy traffic. The method can include the operation of receiving a data stream from an electronic communication network. Another operation can be checking the data stream to determine whether the data stream is being sent over a defined port number. The data stream that is not being sent over the defined port number can be tested to determine whether the data stream is a connected data stream. A user can be blocked from receiving the connected data stream that is not being sent over the defined port number.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic diagram illustrating network components and operations used to block anonymous proxy traffic in accordance with an embodiment of the present invention; and

FIG. 2 is a flow chart illustrating an embodiment of a method of blocking anonymous proxy traffic.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

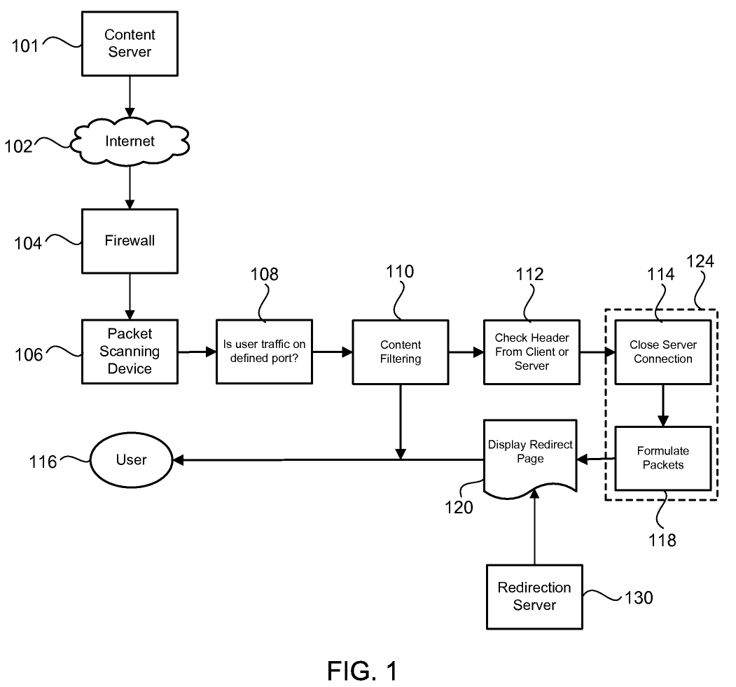

A system and method are provided for blocking anonymous proxy traffic as illustrated in FIG. 1. Users desire to send and receive data streams to and from the network nodes or content servers 101 on the Internet 102 or a similar packet switched network. A data stream can be a generally continuous stream of packets or messages that is generated by a computer program or application when the program is communicating across the network. As mentioned previously, these communications may take place using TCP/IP, HTTP, FTP, TELNET and other communication protocols.

A user 116 associated with one or more of the data streams can also be identified. A user can be anything that has a network address, such as an end user who logs into a computer, a printer, a network attached storage, cell phones, personal digital assistants (PDAs) or other similar devices. These data streams can pass through a firewall 104 and into a packet scanning device 106 for managing network traffic to and from network nodes or content servers 101 on the Internet.

As discussed above, the end users or clients 116 can use an anonymous proxy server that is employed to make the requests from a target server which then passes the data back to the client in an anonymous fashion to circumvent the client network's content filtering. Anonymous proxy servers are able to circumvent content filters by communicating with the end client through network communication ports other than the commonly used port numbers. For example, instead of using port 80 for HTTP services, another randomly numbered port can be used for HTTP. Sometimes an anonymous proxy server is used to hide a client's IP address to the outside world and prevent outside monitoring of the client through the Internet.

In order to stop a client or end user from using an anonymous proxy server to defeat content filtering and bandwidth shaping, certain system components and methods can be used. More specifically, a packet scanning device 106 can be configured to check a data stream to determine whether the data stream is being sent over a pre-defined port number 108. The typical pre-defined ports that are being watched for are port 80 (HTTP), port 21 (FTP), and other commonly used Internet ports. The average user of the internet does not generally use more than 5 or 6 out of the 65536 available internet ports, while most use only one or two ports.

This checking operation can be located in a separate software module that communicates with the packet scanning device or the functionality may be programmed into the packet scanning device itself. The location of other modules and functions described below may also vary depending on the actual system implementation without detracting from the overall functions or results provided by the system and method.

A content filtering module 110 configured to filter the contents of one or more data streams can also be provided. The content filter module can block defined content by topic, web site address, key words, defined URLs, and other similar criteria. The content filtering may be applied if the data stream is communicating on port 80 or to another pre-defined port that is being analyzed. Otherwise, the content filtering step may be skipped when the identified port is not expected to be an HTTP port or a similar port that needs filtering. Other checks of the data stream can be made to confirm that the data stream may not need filtering.

A testing module is provided that is in communication with the packet scanning device to determine whether the data stream sent over a port other than the pre-defined port number is a TCP data stream. This test can be performed by checking the headers of packets that are traveling in both directions in the data stream 112. In this embodiment, the client or client application may have data streams and requests blocked that are TCP in nature, which are being sent on a different port. This is also true of the server sending data to the client.

In one embodiment, the system and method can check the HTTP headers of the TCP data stream when they exist. The information that may be checked in the HTTP header includes the GET/POST/PUT requests. If it is determined that a HTTP header/request does exist, the system marks the TCP connection to have further checking once the server replies to the request. If no headers exist, then connection is marked accordingly for no further checking to maintain the overall performance and throughput. Once the reply from the server is received the HTTP headers of the reply message(s) can be checked. Protocols other than HTTP can also be check in the same manner (e.g. FTP and others). If it is determined that the server reply is HTTP by the existence of HTTP headers in the server reply, the connection to the server can be terminated as described below.

As mentioned, if the data stream is a TCP or HTTP data stream received from server on an unexpected port, then the data stream can be blocked. A blocking module 124 can be in communication with the packet scanning device and testing module. This blocking module can stop a user from receiving a TCP data stream that is not being sent over the defined port number. The blocking module can first close the connection 114 to the content server that is sending information to the end user. The connection is closed when the data stream has been determined to be a TCP data stream (e.g., HTTP) that is being sent over an unexpected port.

Then a redirect to a separate web server 130 can take place. This web server can be located within the packet scanning device or the web server may simply be accessible within the local network and configured respond to a redirection command for the data stream. The web blocking module 124 can then formulate new packets 118 that are capable of being sent to the user. This may entail formulating packets that can be sent to a specific application type or packets that have specific addressing schemes. In other words, the packets are formulated by a designated device or process in the data flow communications channel (e.g., the packet inspection device, a router, a switch, etc.) to send an HTTP 302 REDIRECT response to the client that looks like it came from the server. The browser obeys this 302 REDIRECT and is sent to the URL of the redirection server to inform the user why his connection has been denied. Once reformulated packets have been created, then the payload of the reformulated packets can be a redirected web page 120 stating that an anonymous proxy server may not be used.

The main port that will be checked in this embodiment is the HTTP port or port 80. This is because the majority of traffic that is desired to be blocked comes across port 80. However, it should be realized that ports for other protocols such as the FTP protocol (port 21), secure socket layer (SSL), or other protocols may also be analyzed and blocked.

It is also helpful to understand that the packet scanning device can also be setup for bandwidth shaping of data streams for user applications. The means the blocking of anonymous proxy servers can be performed in combination with bandwidth shaping. For example, the packet scanning device can include user rules for the data streams associated with each identified user. The user rule may define bandwidth allocation among the users. An application class for each of the data streams can also be identified. An application class can be application types such as peer-to-peer applications, database applications, email, streaming audio or video applications, etc. The application class can be also be defined for named applications.

An application class rule can be applied for the data streams associated with each application class. The application class rule can define bandwidth allocation among the application classes or between data streams within an application class. The initial provisioning of the bandwidth is generally performed by taking into account the limitations of the user rule and/or the application class rule to arrive at a calculated amount of bandwidth that the data stream will be allowed to consume to transmit packets or data. Any data sent using a given data stream that exceeds the defined amount of bandwidth may be restricted or delayed until the data packets are able to be sent using just the amount of bandwidth allocated to the user and/or identified application.

The management system can determine how many users or applications are attempting to utilize a given network connection and can provide managed bandwidth access or even equal shares for the available bandwidth. For example, if five users are accessing the Internet using web browsing applications from their desktop computers, the system may provide all of the five users with the same amount of bandwidth, regardless of when they started their browsing sessions. In a different example, if two different types of applications or protocols (e.g., FTP download and HTTP) are in use, the system can still provide managed access to both applications even if one protocol is more greedy that the other.

When additional applications or users begin accessing the network connection, the bandwidth management system can continue to provide managed access to all users, regardless of application, protocol, user or the order in which they sought access to the system. Certain types of network traffic may be classified by a system administrator or management personnel as more important or less important than other types of network traffic or data streams.

By prioritizing applications and protocols, using user rules, and using application rules, the bandwidth management system can then use these relative priorities and rules to determine which kinds of traffic and data streams are passed through immediately, which are delayed while more important traffic passes, and which data streams are denied passage entirely.

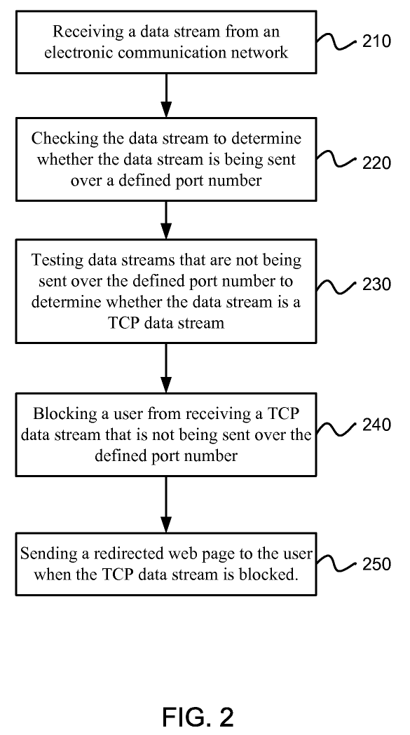

FIG. 2 illustrates a method of stopping or blocking anonymous proxy traffic. The first operation can be receiving a data stream from an electronic communication network, as in block 210. The electronic communication network may be a wide area network (WAN), the Internet, or another connected network. The data stream may be a data stream sent between a web server and a web browser on an end user's computer or another TCP data stream. The data stream can then be checked to determine whether the data stream is being sent over a defined port number, as in block 220. The defined or pre-defined port number is one of a group of port numbers that data streams are expected to be received over, and if the data stream is received over an unexpected port number this may indicate the port is being used for anonymous proxy traffic.

If the data stream is not being sent over the defined port number then the data stream can be tested to determine whether the data stream is a connected data stream, as in block 230. The connected data stream may be a TCP stream, HTTP stream or a FTP stream. In the case of an HTTP data stream, a check can be applied to make sure the data stream is on port 80. In the case of an FTP data stream, a check can be applied to determine whether the data stream is being sent over port 21. The checks can be made by analyzing the packet headers that are outgoing to a server or ingoing to the end user over the network. A user who is trying to receive a connected data stream or TCP stream that is not being sent over the defined port number can be blocked from receiving the data stream, as in flow chart block 240.

In one embodiment, the blocking operation may be simply not allowing the data stream to be sent to the end user. The blocking may be performed by simply closing the server connection. This would appear to the end user as hanging of the application or the loss of data transmission. While such a solution may be effective, it can be difficult for the system administrators to explain to end users.

In another embodiment, the client's data stream can be redirected to a redirection web server. The packet analysis device, web server, or another device can formulate redirected packets for the TCP data stream and load the formulated packets with information containing a redirected web page obtained from the redirection web server. A redirected web page can be sent to the user from the redirection web server when the connected data stream, TCP stream, or HTTP stream is blocked. This more effective from a customer support stand point than just dropping the data stream because the end user is clearly notified that the use of anonymous proxies is not allowed.

Content filtering can also be applied when the user traffic is HTTP traffic. The system will have determined that a data stream is HTTP traffic by checking the packet headers sent from the client to a server in order (or vice-versa) to determine whether the data stream is HTTP. As a result, the system will know that content filter can effectively be applied to the specific data stream type.

In summary, the present system and method helps system administrators more effectively manage their system. Because users cannot use anonymous proxy servers, the users are less likely to be able to avoid content filters and other similar bandwidth shaping and reduction processes.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of blocking anonymous proxy traffic, comprising:
communicating a data stream between an electronic communication network and a user;
checking the data stream to determine whether the data stream is being sent over a defined port number;
testing the data stream that is not being sent over the defined port number to determine whether the data stream is a connected data stream;
blocking a user from receiving the connected data stream that is not being sent over the defined port number.

2. A method as in claim 1, further comprising the step of sending a redirected web page to the user when the connected data stream is blocked.

3. A method as in claim 1, further comprising the step of checking the data stream to determine whether the data stream is being sent over port 80 for HTTP.

4. A method as in claim 1, further comprising the step of checking the data stream to determine whether the data stream is being sent over port 21 for FTP.

5. A method as in claim 1, wherein the connected data stream can be a TCP data stream connected at the application level.

6. A method as in claim 6, further comprising the step of checking packet headers from the client to determine if HTTP traffic is being sent from the client and blocking the data stream if the data stream is not HTTP.

7. A method as in claim 6, further comprising the steps of checking packet headers from a server to determine whether a response to the connected data stream is HTTP and blocking the data stream if the data stream is not HTTP.

8. A method for blocking anonymous proxy traffic, comprising:
receiving a data stream from a packet switching network;
checking the data stream to determine whether the data stream is being sent over a pre-defined port number;
testing data streams that are not being sent over the pre-defined port number to determine whether the data stream is a TCP data stream;
blocking a user from receiving a TCP data stream that is not being sent over the defined port number.

9. A method as in claim 8, further comprising the step of sending a redirected web page to the user when the TCP data stream is blocked.

10. A method as in claim 8, further comprising the step of checking the data stream to determine whether the data stream is being sent over port 80.

11. A method as in claim 8, further comprising the step of blocking a user by closing the server connection.

12. A method as in claim 11, further comprising the step of redirecting the client to a redirection web server.

13. A method as in claim 12, further comprising the step of formulating packets for the TCP data stream that contain information from a redirected web page.

14. A method as in claim 8, further comprising the step of applying content filtering to user traffic when the user traffic is HTTP traffic.

15. A method as in claim 8, further comprising the step of checking packet headers sent from the user to a server in order to determine whether the data stream is HTTP.

16. A method as in claim 8, further comprising the step of checking packet headers from a server to the user in order to determine whether the data stream is HTTP.

17. A system for blocking anonymous proxy traffic, comprising:
a packet scanning device configured to check a data stream and determine whether the data stream is being sent over a pre-defined port number;
a testing module in communication with the packet scanning device to determine whether the data stream that is not sent over the pre-defined port number is a TCP data stream;
a blocking module in communication with the packet scanning device configured to stop a user from receiving a TCP data stream that is not being sent over the pre-defined port number.

18. A system as in claim 17, further comprising a redirection web server to which the blocking module redirects a TCP data stream to a redirection server upon determination that the data stream is not being sent over the pre-defined port number.

19. A system as in claim 17, wherein the defined port number is an HTTP port.

20. A system as in claim 17, further comprising a content filtering module can be configured to filter contents of the TCP data stream.
